(19) United States
(12) Patent Application Publication
(10) Pub. No.: US 2008/0204622 A1
(43) Pub. Date: Aug. 28, 2008

(54) DISPLAY APPARATUS

(76) Inventors: Hoe-Woo You, Seoul (KR); Young-Joo Park, Hwaseong-si (KR); Young Kim, Seoul (KR); Jin-Hee Park, Seoul (KR)

Correspondence Address: F. CHAU & ASSOCIATES, LLC, 130 WOODBURY ROAD, WOODBURY, NY, 11797, US

(21) Appl. No.: 12/035,893

(22) Filed: Feb. 22, 2008

(30) Foreign Application Priority Data
Feb. 23, 2007 (KR) 2007-18252

(51) Int. Cl. G02F 1/1335; G02F 1/1333

(52) U.S. Cl. 349/58; 349/65

(57) ABSTRACT

A display apparatus includes a receiving frame, a front-light module, a cover member and a display panel. The receiving frame has side walls which are formed around an open portion. The front-light module includes a light-guide plate disposed in the receiving space and a light source disposed between the light-guide plate and at least one side wall. The cover member is disposed over the side walls, to cover the light source and an upper surface of the light-guide plate. The display panel module includes a liquid crystal display (LCD) panel facing the light-guide plate and disposed under the front-light module in the receiving space, and a driving printed circuit film extending along the side wall from an edge of the LCD panel to the cover member. Thus, prism patterns of the light-guide plate may be protected and a mounting area of driving elements may be increased.

### CROSS-REFERENCE TO RELATED APPLICATIONS

This application claims priority under 35 U.S.C. §119 to Korean Patent Application No. 2007-18252, filed on Feb. 23, 2007 in the Korean Intellectual Property Office (KIPO), the contents of which are herein incorporated by reference in their entirety.

### BACKGROUND OF THE INVENTION

1. Technical Field

The present invention relates to a display apparatus, and more particularly, to a display apparatus having a compact combining structure while providing enough space for a plurality of driving devices.

2. Discussion of the Related Art

A liquid crystal display (LCD) apparatus may be classified as a transmissive-type LCD apparatus or a reflective-type LCD apparatus, according to a method of using the light source. The transmissive-type LCD apparatus has a backlight module. The reflective-type LCD apparatus displays an image using external light, or has a front-light module. The reflective-type LCD apparatus consumes less power, and can be lighter and occupy less volume than a transmissive-type LCD apparatus.

The front-light module can be applied to a dual display apparatus of a mobile display apparatus such as a cellular phone. The dual display apparatus that has one display panel and displays different images in different directions, for example, upward and downward directions, can be applied to the mobile display apparatus such as the cellular phone.

The mobile display apparatus such as the cellular phone is designed according to design rules based on human engineering. Thus, the size of the mobile display apparatus is limited. Elements driving an application module such as a liquid crystal panel, a speaker, a motor, a camera and so on, are mounted on a flexible printed circuit (FPC) film. Thus, the FPC requires sufficient mounting area for the elements. In the mobile display apparatus having the backlight module, the FPC is extended toward a rear surface of the backlight module.

However, in the display apparatus having the front-light module, in order to enhance brightness, a surface of a prism pattern is disposed at a side of the light-guide plate, differently from the conventional backlight module. Thus, in order to protect prisms formed on the surface of the prism pattern, the FPC is not disposed on the surface of the prism pattern. Particularly, in the dual display apparatus, a display screen is disposed in the upward direction and the downward direction, so that an area in which the FPC is mounted is decreased.

Thus, a mobile display apparatus, such as a mobile phone including a display apparatus having a front-light module and a reflective-type LCD panel, requires sufficient area on which elements are mounted, while being suitably small in size in accordance with human engineering guidelines.

### SUMMARY OF THE INVENTION

Embodiments of the present invention provide a display apparatus having a compact combining structure.

A display apparatus, according to an embodiment of the present invention, includes a receiving frame, a front-light module, a cover member and a display panel. The receiving frame has a plurality of side walls defining a receiving space, wherein the side walls are formed around an opening. The front-light module includes a light-guide plate disposed in the receiving space and a light source disposed between a side surface of the light-guide plate and at least one side wall. The cover member is disposed over the side walls, to cover the light source and a portion of an upper surface of the light-guide plate adjacent to the light source. The display panel module includes a liquid crystal display (LCD) panel and a driving printed circuit film. The LCD panel faces the light-guide plate, and is disposed under the front-light module in the receiving space. The driving printed circuit film extends along the side wall adjacent to the light source from an edge of the LCD panel toward the cover member. The driving printed circuit film wraps around the side wall adjacent to the light source.

The driving printed circuit film may include a panel printed circuit film and an interface printed circuit film. The panel printed circuit film may be electrically connected to the LCD panel and may extend along the side wall adjacent to the light source to the cover member. The interface printed circuit film may be integrated on a portion of the panel printed circuit film that is disposed on the cover member, wherein the interface printed circuit film is electrically connected to the panel printed circuit film.

The light source may include a light-guide bar and point light sources. The light-guide bar may include a light-emitting surface, light-incident surfaces and an upper surface. The light-emitting surface may face the side surface of the light-guide plate. The light-incident surfaces may face each other, and may be connected to the light-emitting surface. The upper surface may be connected to the light-emitting surface and the light-incident surfaces, and may face a lower surface of the cover member. The point light sources may be disposed on each light-incident surface. The light source may further include a power source printed circuit film on which the point light sources are mounted, and the power source printed circuit film is disposed along a lengthwise direction of the light-guide bar. The power source printed circuit film may be attached to the lower surface of the cover member.

The cover member may be a printed circuit board (PCB) on which the point light sources are mounted.

The cover member may include an upper plate, a sidewall and a lower plate. The upper plate may cover the light source and the portion of the upper surface of the light-guide plate. The sidewall may face the side surface of the light-guide plate, and the light-guide bar may be disposed between the sidewall and the light-guide plate. The lower plate may face a lower surface of the light-guide bar.

The LCD panel may include an upper substrate, a lower substrate and a liquid crystal layer. The upper substrate may face a lower surface of the light-guide plate and may have a plurality of color filters formed on the upper substrate. The lower substrate may be electrically connected to the panel printed circuit film, and may include a transmissive pixel transmitting light having passed through the color filter to display a first image based on the transmitted light and a reflective pixel reflecting the light having passed through the color filter to display a second image based on the reflected light. The liquid crystal layer may be disposed between the upper substrate and the lower substrate.

A prism pattern spaced apart from the cover member may be formed on an upper surface of the light-guide plate.

The display panel module may further include a first driving element disposed on the interface printed circuit film corresponding to the cover member, to drive the LCD panel. The display panel module may further include a second driving element disposed on the panel printed circuit film corresponding to the cover member, to drive the LCD panel. An opening, into which the second driving element is inserted, is formed through the interface printed circuit film. The display apparatus may further include an application module disposed around the LCD panel, and the display panel module may further include a third driving element disposed on the panel printed circuit film or the interface printed circuit film corresponding to the cover member, to drive the application module.

The display apparatus may further include a driving substrate electrically connected to the interface printed circuit film and outputting a panel driving signal to the interface printed circuit film for driving the LCD panel. The display apparatus may further include a receiving container combined with the receiving frame, wherein the receiving container is rotated or translated with respect to the receiving frame, and receives the driving substrate.

A display apparatus according to an embodiment of the present invention, includes a receiving container, an LCD panel, a light-generating module, a cover member and a printed circuit film. The receiving container has at least two openings, to emit light in upward and downward directions. The LCD panel is received by the receiving container, and displays a first image in the downward direction and a second image in the upward direction. The light-generating module is received in the receiving container, and includes a light-guide plate facing the LCD panel and a light source facing a side surface of the light-guide plate. The cover member covers the light source and a portion of the light-guide plate adjacent to the light source. The printed circuit film extends from the LCD panel, and is curved to enclose the light source and the cover member.

The LCD panel may be divided into a display area in which the second image is displayed through one of the at least two openings of the receiving container and a peripheral area covered by the receiving container. The cover member may cover the peripheral area.

According to the embodiments of the present invention, the display apparatus having a compact size may be manufactured.

### BRIEF DESCRIPTION OF THE DRAWINGS

Embodiments of the present invention can be understood in more detail from the following description taken in conjunction with the accompanying drawings, in which:

FIG. 1 is a perspective view illustrating a mobile device having a display apparatus according to an example embodiment of the present invention;

FIG. 2 is a perspective view illustrating the display apparatus shown in FIG. 1;

FIG. 3 is an exploded perspective view illustrating the display apparatus in FIG. 2;

FIG. 4 is a cross-sectional view taken along a line I-I′ in FIG. 3;

FIG. 5 is a cross-sectional view taken along a line II-II′ in FIG. 3;

FIG. 6 is a cross-sectional view illustrating a display panel illustrated in FIG. 3;

FIG. 7 is a plan view illustrating a lower substrate illustrated in FIG. 6;

FIG. 8 is a cross-sectional view illustrating a display apparatus according to an example embodiment of the present invention; and

FIG. 9 is a cross-sectional view illustrating a display apparatus according to an example embodiment of the present invention.

### DESCRIPTION OF EXEMPLARY EMBODIMENTS

Exemplary embodiments of the present invention are described more fully hereinafter with reference to the accompanying drawings. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

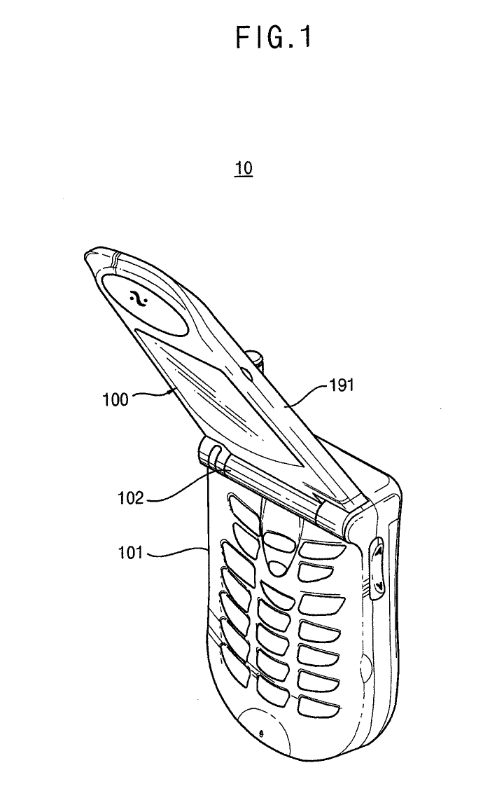

FIG. 1 is a perspective view illustrating a mobile device 10 having a display apparatus 100 according to an example embodiment of the present invention.

Referring to FIG. 1, the mobile device 10 is a folder-type cellular phone. The mobile device 10 includes a folding part 191 having a display apparatus 100, and a body part 101 having a driving substrate driving the display apparatus 100 and a plurality of buttons. The folding part 191 is combined with the body part 101 using a hinge, so that the folding part 191 rotates with respect to the body part 101.

For example, the mobile device 10 such as the cellular phone may be designed to have a predetermined size, according to design rules based on human engineering. For example, a ratio of width to length in the folding part 191 of the mobile device 10 may be designed to be about 1:2, and the ratio of width to length in a display screen of the display apparatus 100 may be designed to be about 3:4.

The display apparatus 100 may be electrically connected to the driving substrate through a driving printed circuit film. The display apparatus 100 may include a display panel such as a liquid crystal display (LCD) panel and a light source emitting light. The display panel displays an image based on the light generated from the light source. The printed circuit film is connected to the display panel, and may be electrically connected to the driving substrate received in the body part 101. A connection of the printed circuit film to the driving substrate may be around a connecting portion 102 connecting the folding part 191 with the body part 101.

An element, such as a timing controller and a power control element, driving the LCD panel may be disposed on the driving printed circuit film.

The mobile device 10 such as the cellular phone may further include application modules such as a camera, a speaker, a motor, a vibrator and so on, and the application modules are disposed in the folding part 191 or the body part 101. Driving elements driving the application modules may be mounted on the driving printed circuit film.

Thus, a driving printed circuit board (PCB) may have sufficient width and length, so that a space in which the elements for driving the LCD panel and the application modules are mounted may be increased.

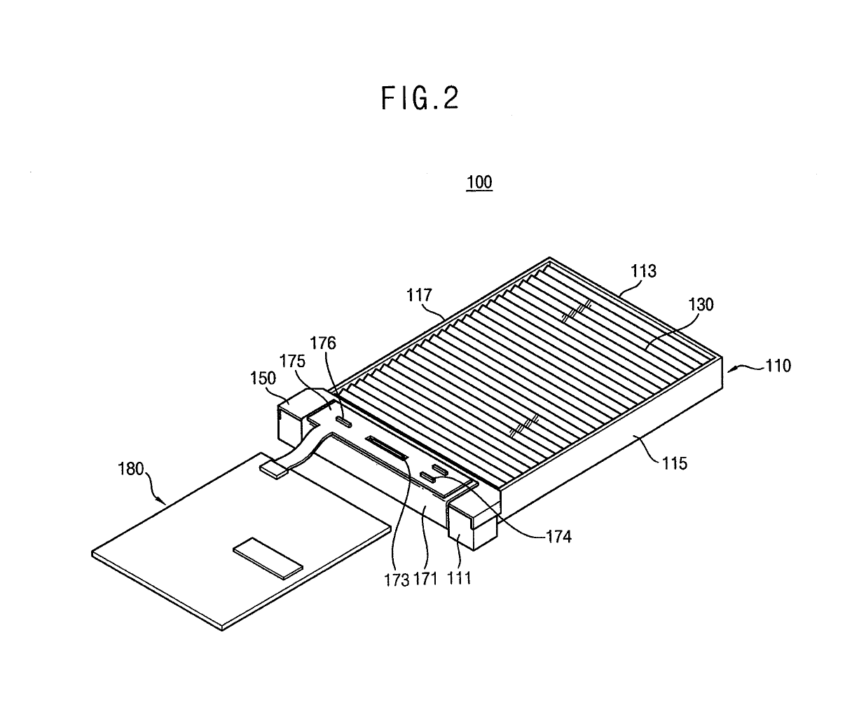

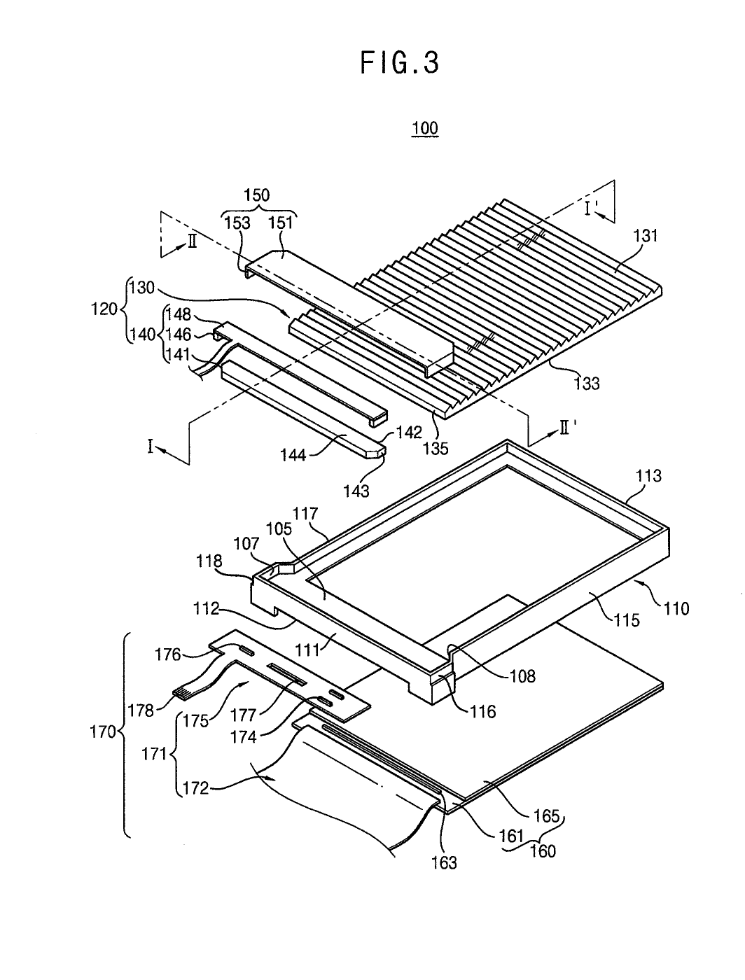

FIG. 2 is a perspective view illustrating the display apparatus shown in FIG. 1. FIG. 3 is an exploded perspective view illustrating the display apparatus 100 in FIG. 2.

Referring to FIGS. 2 and 3, the display apparatus 100 includes a receiving frame 110, a front-light module 120, a cover member 150 and a display panel module 170. The display apparatus 100 may be used for the mobile device 10 such as the cellular phone illustrated in FIG. 1.

The receiving frame 110 includes a receiving space. The front-light module 120 is disposed in an upper portion of the receiving space, and the display panel module 170 is disposed in a lower portion of the receiving space.

“Upper” described herein represents a direction toward the front-light module 120 from the display panel module 170, and “lower” described herein represents a direction toward the display panel module 170 from the front-light module 120.

The receiving frame 110 receives the front-light module 120 and the display panel module 170. The receiving frame 110 has a frame shape around an open portion. The receiving frame 110 includes first, second, third and fourth side walls 111, 113, 115 and 117, and a supporting portion 105.

The first side wall 111 faces the second side wall 113. The third side wall 115 faces the fourth side wall 117, and is connected to the first and second side walls 111 and 113. The first, second, third and fourth side walls 111, 113, 115 and 117 form the receiving space. The third and fourth side walls 115 and 117 protrude in opposite directions at end portions thereof adjacent to the first side wall 111. As a result, light source grooves 107 and 108 are formed inside of the third and fourth side walls 115 and 117 adjacent to the first side wall 111. A guide groove 112 is formed at a lower side of the first side wall 111.

The supporting portion 105 protrudes from inner surfaces of the first, second, third and fourth side walls 111, 113, 115 and 117 by predetermined widths. The supporting portion 105 may protrude along central lines of the inner surfaces of the first, second, third and fourth side walls 111, 113, 115 and 117. The supporting portion 105 may have a substantially rectangular frame shape when viewed on a plane. Thus, the supporting portion 105 may divide the receiving space into the upper and lower portions.

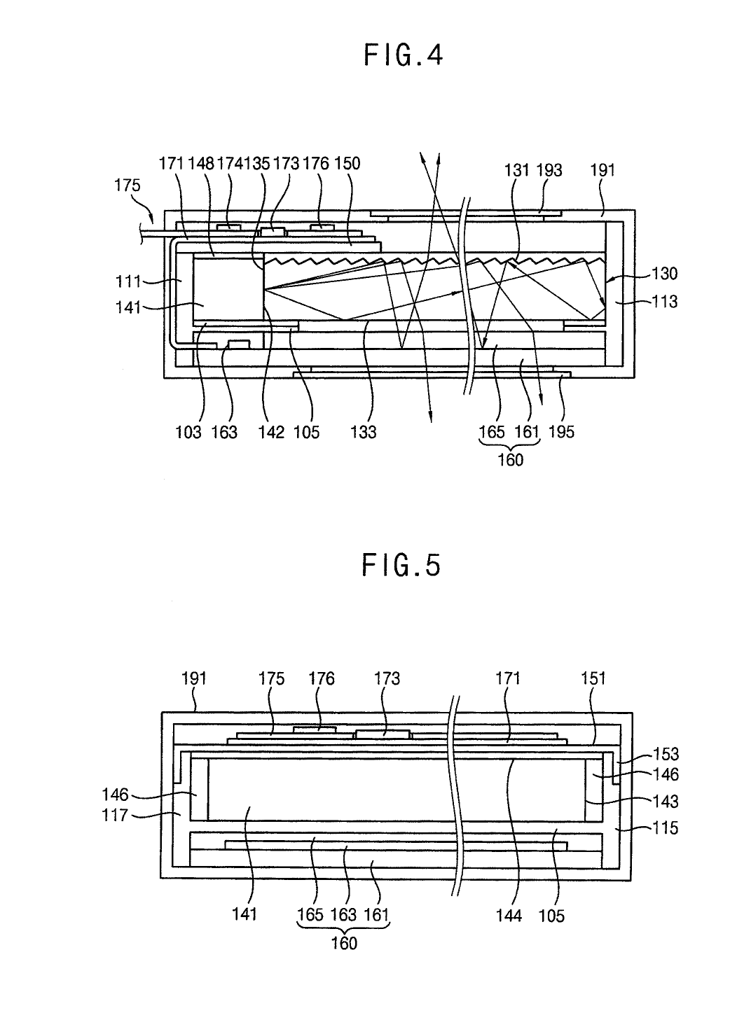

FIG. 4 is a cross-sectional view taken along a line I-I′ in FIG. 3.

Referring to FIGS. 3 and 4, the front-light module 120 includes a light-guide plate 130 and a light source 140.

The light-guide plate 130 guides incident light, and increases brightness and luminance uniformity of the incident light. The light-guide plate 130 is disposed in the upper portion of the receiving frame 110, and is supported by the supporting portion 105. The light-guide plate 130 is spaced apart from the first side wall 111 by width of the light source 140.

The light-guide plate 130 includes a plurality of side surfaces 135, a prism pattern surface 131 and a counter surface 133. The light is incident into at least one side surface 135 of the light-guide plate 130. The prism pattern surface 131 is an upper surface of the light-guide plate 130. Prism patterns having a substantially triangular cross-section are formed on the prism pattern surface 131. The prism patterns may extend substantially in parallel with the first side wall 111. The prism pattern surface 131 enhances luminance in an upward direction.

Each of the prism patterns may include two inclined surfaces facing each other. For example, each of the prism patterns may include a reflective surface and a transmissive surface. In FIG. 4, the reflective surface mostly reflects the light-incident into the light-guide plate 130 through the side surface 135 of the light-guide plate 130 toward a lower side of the light-guide plate 130. For example, the light reflected from the reflective surface of the prism patterns may be guided toward the display module 170. The transmissive surface transmits the light reflected from the display panel module 170.

The light-guide plate 130 may include a light-guiding material having various characteristics such as good transmissivity, heat resistance, chemical resistance, and mechanical strength. Examples of the light-guiding material that may be used for the light-guide plate 130 include polymethyl methacrylate, polyamide, polyimide, polypropylene, polyurethane, etc. The thickness of the light-guide plate 130 may be uniform. Alternatively, the thickness of the light-guide plate 130 may be increased, as a distance from a first side of the light-guide plate 130 is increased toward a second side of the light-guide plate 130 opposite to the first side.

The light source 140 emits the light toward the side surface 135 of the light-guide plate 130. The light source 140 is disposed between the first side wall 111 and the side surface 135 of the light-guide plate 130. The light source 140 may include a light-guide bar 141 and a plurality of point light sources 146.

The light-guide bar 141 has a bar shape extending along a longitudinal direction of the first side wall 111. The light-guide bar 141 is disposed on the supporting portion 105 and is disposed between the first side wall 111 and the light-guide plate 130. The light-guide bar 141 includes a light-emitting surface 142, a reflective pattern surface, light-incident surfaces 143, an upper surface 144 and a lower surface.

The light-emitting surface 142 faces the side surface 135 of the light-guide plate 130. The reflective pattern surface faces the light-emitting surface 142. A reflective pattern may be formed on the reflective pattern surface, to guide the light-incident into the light-guide bar 141 through the light-incident surface 143 toward the light-emitting surface 142. The light-incident surfaces 143 are positioned on opposite ends of the light-guide bar 141 to face each other, and are connected to the light-emitting surface 142 and the reflective pattern surface. The upper surface 144 and the lower surface face each other, and are connected to the light-emitting surface 142, the reflective pattern surface and the light-incident surfaces 143. The light-guide bar 141 may include substantially the same light-guiding material as the light-guide plate 130.

The receiving frame 110 may further include a light-reflecting layer 103 formed on the supporting portion 105. The light-reflecting layer 103 reflects the light leaking through a space between the lower surface of the light-guide bar 141 and the light-guide plate 130, to guide the light into the light-guide bar 141 and the light-guide plate 130.

FIG. 5 is a cross-sectional view taken along a line II-II′ in FIG. 3.

Referring to FIGS. 3 to 5, the point light source 146 emits light to the light-incident surface 143 of the light-guide bar 141. The point light source 146 is disposed in each of the light source grooves 107 and 108 of the receiving frame 110, and faces the light-incident surface 143 of the light-guide bar 141. The point light source 146 may include a blue light-emitting chip emitting blue light and a yellow fluorescent body covering the blue light-emitting chip. The blue light emitted by the blue light-emitting chip passes through the yellow fluorescent body to be converted into white light, and the white light is incident into the light-guide bar 141 through the light-incident surface 143 of the light-guide bar 141.

The light source 140 may further include a power source printed circuit film 148.

The power source printed circuit film 148 applies a power source provided from an external power source part to the point light sources 146. The power source printed circuit film 148 may extend along the upper surface or the lower surface of the light-guide bar 141. In FIGS. 4 and 5, the power source printed circuit film 148 is disposed on the upper surface of the light-guide bar 141. The point light sources 146 are mounted on opposite end portions of the power source printed circuit film 148. The power source printed circuit film 148 may be partially drawn outside of the receiving frame 110.

The cover member 150 may protect the prism patterns formed on the prism pattern surface 131 of the light-guide plate 130, and provides an area on which certain elements are mounted. The cover member 150 covers the light source 140 and a peripheral portion of the prism pattern surface 131 of the light-guide plate 130 adjacent to the light source 140. The cover member 150 may include an upper plate 151 and a sidewall 153.

The upper plate 151 of the cover member 150 may be supported by the first, third and fourth side walls 111, 115 and 117 of the receiving frame 110. The upper plate 151 covers the light-guide bar 141 and the point light sources 146, and also covers the upper surface of the light-guide plate 130 adjacent to the light-guide bar 141. For example, the upper plate 151 may cover the peripheral portion of the prism pattern surface 131.

An area of the upper plate 151 covering the prism pattern surface 131 depends on the size of the display screen of the display apparatus 100. The display apparatus 100 according to the present example embodiment displays a first image in the downward direction and a second image in the upward direction. Thus, the size of the display screen displaying the second image may change the area of the upper plate 151 covering the prism pattern surface 131. The upper plate 151 may be spaced apart from the prism patterns to protect the prism patterns formed on the prism pattern surface 131.

The sidewalls 153 of the cover member 150 extend from opposite end portions of the upper plate 151, and face the third and fourth side walls 115 and 117. The sidewalls 153 may be disposed in fixing grooves 116 and 118 that are respectively formed at the third and fourth side walls 115 and 117.

The cover member 150 may include a plastic material or a metallic material, and may have a thin thickness. For example, the cover member 150 may include stainless steel. In addition, the thickness of the cover member 150 may be in a range between about 0.1 mm to about 0.2 mm.

The cover member 150 may be attached to an upper portion of the first, third and fourth side walls 111, 115 and 117. Alternatively, the cover member 150 may be received in the fixing grooves 116 and 118 through an adhesive element, and may be attached to the third and fourth side walls 115 and 117. Alternatively, the sidewall 153 of the cover member 150 may have a combining protrusion, and a combining groove. A combining hole into which the combining protrusion is inserted may be formed through each of the third and fourth side walls 115 and 117. For example, the cover member 150 may be combined with the third and fourth side walls 115 and 117 through a hook combination.

The cover member 150 may include a material absorbing the light. Thus, the display quality of the display apparatus may be improved by preventing reflection of the light reflected from a surface of the cover member 150. For example, the surface of the cover member 150 may include a light-absorbing material having a dark color, for example, a black color.

The power source printed circuit film 148 may be attached to a lower surface of the upper plate 151 of the cover member 150. Thus, the cover member 150, the power source printed circuit film 148 and the point light source 146 form one module combined with the receiving frame 110.

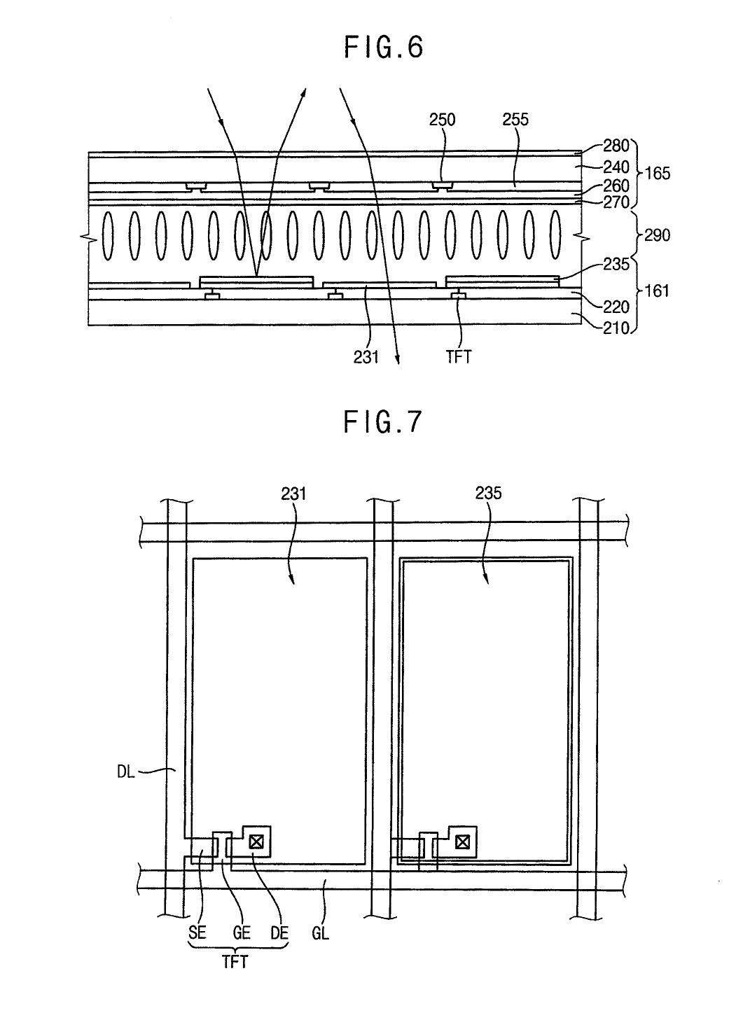

FIG. 6 is a cross-sectional view illustrating a display panel illustrated in FIG. 3. FIG. 7 is a plan view illustrating a lower substrate illustrated in FIG. 6.

Referring to FIGS. 3, 6 and 7, the display panel module 170 includes an LCD panel 160 and a driving printed circuit film 171.

The LCD panel 160 displays the first and second images based on a panel driving signal applied from the driving printed circuit film 171 and the light provided from the front-light module 120. For example, the LCD panel 160 of the present example embodiment may be a dual display apparatus displaying the first image in the downward direction and the second image in the upward direction.

The LCD panel 160 may be disposed in the lower portion of the receiving space and may be supported by the supporting portion 105. Thus, the LCD panel 160 faces the counter surface 133 of the light-guide plate 130.

The LCD panel 160 includes a lower substrate 161, an upper substrate 165 and a liquid crystal layer 290.

The lower substrate 161 may include a lower base substrate 210, a thin-film transistor layer 220, a transmissive pixel 231 and a reflective pixel 235.

The lower base substrate 210 may be an optically isotropic glass substrate. The thin-film transistor layer 220 may include signal lines and a switching element TFT applying a data signal and a gate signal to the transmissive pixel 231 and the reflective pixel 235 according to the panel driving signal.

The signal lines include a data line DL transmitting the data signal and a gate line GL transmitting the gate signal that controls the switching element TFT. The gate and data lines GL and DL are electrically insulated from each other by a gate insulating layer, and cross each other.

The switching element TFT may include a source electrode SE electrically connected to the data line DL, a gate electrode GE electrically connected to the gate line GL and a drain electrode DE electrically connected to the transmissive pixel 231 or the reflective pixel 235.

The reflective pixel 235 or the transmissive pixel 231 may be formed in each of unit pixel areas on the thin-film transistor layer 220. The transmissive pixel 231 and the reflective pixel 235 may be sequentially arranged or may be arranged with a predetermined pattern. The transmissive pixel 231 may include a transparent conductive material such as indium tin oxide (ITO) or indium zinc oxide (IZO). The reflective pixel 235 may include a metal thin film having good light reflectivity. For example, the reflective pixel 235 may include aluminum (Al).

The lower substrate 161 may further include a driving part 163 outputting the data and gate signals. The driving part 163 may be mounted on a non-display area of the lower substrate 161 with a chip shape.

The upper substrate 165 may face the lower substrate 161 and make contact with the supporting portion 105. The upper substrate 165 may include an upper base substrate 240 facing the lower base substrate 210, a light-blocking pattern 250, a color filter portion 255, a protective layer 260 and a common electrode 270.

The upper base substrate 240 may include the glass substrate. The light-blocking pattern 250 may have a matrix shape corresponding to the gate and data lines GL and DL of the upper base substrate 240. The light-blocking pattern 250 may include a chromium-based metal or an organic material.

The color filter portion 255 may include a red color filter, a green color filter and a blue color filter. Each of the color filters may correspond to each of the unit pixel areas, and may be formed in each of openings formed through the light-blocking pattern 250. The protective layer 260 may cover the color filter portion 255 to protect the color filter portion 255. The common electrode 270 may include a transparent conductive material. Examples of the transparent conductive material that may be used for the common electrode 270 include indium tin oxide (ITO), indium zinc oxide (IZO), etc. These may be used alone or in a combination thereof.

The liquid crystal layer 290 may be disposed between the upper and lower substrates 165 and 161. An arrangement direction of liquid crystal molecules in the liquid crystal layer 290 may be changed by an electric field generated between the reflective pixel 235 and the common electrode 270, and light transmissivity of the liquid crystal layer 290 may be controlled.

The LCD panel 160 may further include a polarizing plate 280 disposed on the upper substrate 165.

The reflective pixel 235 and the transmissive pixel 231 may independently receive the data signal. Thus, as illustrated in FIGS. 4 and 5, the LCD panel 160 displays the first image, based on the light sequentially passing through the light-guide plate 130, the upper substrate 165, the liquid crystal layer 290 and the transmissive pixel 231 in a downward direction. The LCD panel 160 also displays the second image, based on the light sequentially passing through the light-guide plate 130, the upper substrate 165, the liquid crystal layer 290, the reflective pixel 235, the upper substrate 165 and the light-guide plate 130 in an upward direction.

Alternatively, the LCD panel 160 may be a display panel only including the reflective pixel 235 to display the image in the upward direction.

Referring again to FIGS. 2 and 3, the driving printed circuit film 171 applies the panel driving signal to the LCD panel 160. The driving printed circuit film 171 may be formed by patterning a conductive line on a flexible resin film. The driving printed circuit film 171 extends along and around the first side wall 111, on which the light source 140 is disposed, from the LCD panel 160 toward an end portion of the cover member 150. The driving printed circuit film 171 may also be drawn outside over the first side wall 111 in a reverse direction. Thus, the driving printed circuit film 171 may be integrated on the cover member to have a double layer. Thus, the area of the driving printed circuit film 171, on which the predetermined elements are mounted, may be increased.

The driving printed circuit film 171 may include a panel printed circuit film 172 and an interface printed circuit film 175.

Referring to FIGS. 3 and 4, a first end of the panel printed circuit film 172 may be electrically connected to an edge of the lower substrate 161 on which the driving part 163 is mounted. The driving part 163 is electrically connected to the panel printed circuit film 172 by a line pattern formed on the lower substrate 161. The panel printed circuit film 172 transmits the panel driving signal provided from the driving substrate 180 to the driving part 163.

The panel printed circuit film 172 may extend along an outer surface of the first side wall 111 over the guide groove 112. The panel printed circuit film 172 is curved at an upper portion of the first side wall 111 and extends along the cover member 150. A second end of the panel printed circuit film 172 may be disposed on the cover member 150. The cover member 150, on which the panel printed circuit film 172 is disposed, corresponds to a peripheral portion of the light-guide plate 130 adjacent to the light-guide bar 141.

The panel printed circuit film 172 may include a first terminal. A portion of the panel printed circuit film 172 may be electrically connected to the power source printed circuit film 148, on which the point light sources 146 are mounted.

The interface printed circuit film 175 may overlap the panel printed circuit film 172 on the cover member 150. The interface printed circuit film 175 may be drawn outside of the display apparatus 100 over the first side wall 111. The interface printed circuit film 175 includes a second terminal that is electrically connected to the first terminal.

The display panel module 170 may further include a first driving element 176 generating the panel driving signal. The first driving element 176 may further include the timing controller driving the LCD panel 160. The first driving element 176 may be mounted on the interface printed circuit film 175 corresponding to the cover member 150.

The display panel module 170 may further include a second driving element 173 driving the LCD panel 160. The second driving element 173 may be mounted on the panel printed circuit film 172 corresponding to the cover member 150. For example, an opening 177 into which the second driving element 173 is inserted may be formed through the interface printed circuit film 175 to receive the second driving element 173.

Accordingly, the elements may be selectively mounted on the panel printed circuit film 172 and the interface printed circuit film 175. In the present example embodiment, the panel printed circuit film 172 and the interface printed circuit film 175 are integrated on the cover member 150 to increase the area on which various elements are mounted.

As illustrated in FIGS. 4 and 5, the display apparatus 100 may further include an external housing 191, a first display window 195 and a second display window 193.

For example, the external housing 191 may be the folding part 191 as illustrated in FIG. 1. The external housing 191 receives the display apparatus 100. The external housing 191 encloses the display apparatus 100 excluding the upper display area in which the first image is displayed and the lower display area in which the second image is displayed. Thus, the external housing 191 includes an upper opening and a lower opening.

The first display window 195 covers the lower opening of the external housing 191 and is fixed to the external housing 191 to face the lower substrate 161 of the LCD panel 160. The second display window 193 covers the upper opening and is fixed to the external housing 191 to face the light-guide plate 130 excluding a blocked portion blocked by the cover member 150.

The display apparatus 100 may be the mobile device 10 such as the cellular phone. For example, the display apparatus 100 may further include various application modules such as the speaker, the motor, the vibrator, the camera and so on. The application modules may be fixed to the external housing 191 adjacent to a peripheral portion of the display panel module 170. The third driving element 174 may be mounted on the panel printed circuit film 172 or the interface printed circuit film 175 corresponding to the cover member 150.

Referring again to FIG. 2, the display apparatus 100 may further include a driving substrate 180. The driving substrate 180 may be electrically connected to the interface printed circuit film 175 drawn over the first side wall 111. The driving substrate 180 generates the panel driving signal and applies the panel driving signal to the printed circuit film 175.

The display apparatus 100 may further include a receiving container. For example, the receiving container may be the body part 101 as illustrated in FIG. 1. When the display apparatus 100 is a folder-type cellular phone, the receiving container may be combined with the first side wall 111 using, for example, the hinge, so that the receiving container rotates with respect to the receiving frame 110. When the display apparatus 100 is a slider-type cellular phone, the receiving container may be combined with the receiving frame 110, so that the receiving container moves back and forth with respect to the receiving frame 110.

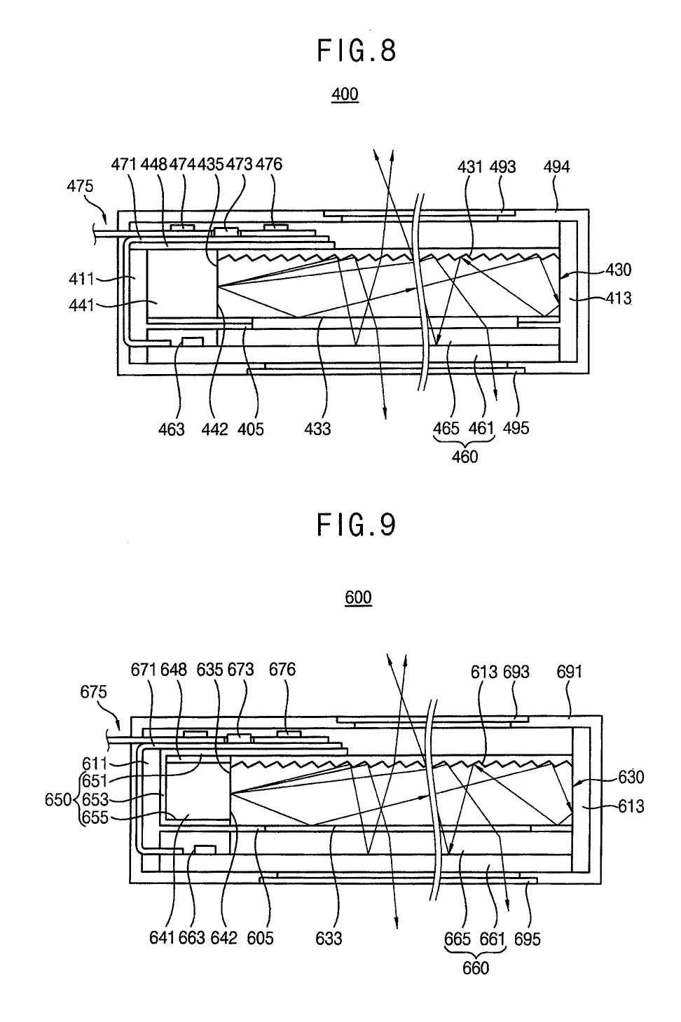

FIG. 8 is a cross-sectional view illustrating a display apparatus according to an example embodiment of the present invention.

Referring to FIG. 8, a display apparatus 400 includes a receiving frame, a front-light module, a cover member 448 and a display panel module. The display apparatus 400 described in connection with FIG. 8 may be substantially the same as the display apparatus 100 illustrated in FIGS. 2 to 7, except with respect to, for example, the front-light module and the cover member 448.

The front-light module includes a light-guide plate 430 and a light source, and the light source includes a light-guide bar 441 and point light sources. The cover member 448 may be substituted for the power source printed circuit film. The cover member 448 may include a base plate, an insulating layer and a metal line having a predetermined strength. For example, the cover member 448 may be a PCB.

The base plate may have substantially the same shape and may be disposed at substantially the same position as the cover member 150 illustrated in FIGS. 2 and 3. The metal line may be formed on a lower surface of the base plate via a photolithography process. The insulating layer covers the metal line to electrically insulate the metal line. The point light sources are mounted on the lower surface of the base plate to be electrically connected to the metal line.

Thus, the cover member 448 may cover prism patterns of the light-guide plate 430 to protect the prism patterns, and functions as a circuit board applying a driving power to the point light sources. Therefore, the number of elements included in the display apparatus 400 may be decreased, and an area on which predetermined circuit elements are mounted may be increased.

FIG. 9 is a cross-sectional view illustrating a display apparatus according to an embodiment of the present invention.

Referring to FIG. 9, a display apparatus 600 includes a receiving frame, a front-light module, a cover member 650 and a display panel module. The display apparatus 600 may be substantially the same as the display apparatus 100 illustrated in FIGS. 2 to 7, except with respect to, for example, the cover member 650.

The cover member 650 includes an upper plate 651, a sidewall 653 and a lower plate 655.

The upper plate 651 is disposed on a first side wall 611, a third side wall and a fourth side wall of the receiving frame, and covers a portion of a prism pattern surface 431 of light-guide plate 630, similar to the upper plate 151 of the cover member 150 illustrated in FIGS. 2 and 3.

The lower plate 655 faces the upper plate 651, and may have substantially the same width as a supporting portion 605 protruded from an inner surface of the first side wall 611.

The sidewall 653 faces the inner surface of the first side wall 611 and is connected to the upper plate 651 and the lower plate 655. Thus, the upper plate 651, the sidewall 653 and the lower plate 655 form a receiving space.

A light-guide bar 641 and a point light source may be disposed in the receiving space. In this case, a power source printed circuit film 648 may be attached to a lower surface of the upper plate 651 of the cover member 650.

Thus, the cover member 650 functions as a reflective plate reflecting the light leaking from the point light source and the light-guide bar 641 toward the light-guide bar 641, and provides the area on which the circuit elements are mounted.

According to the embodiments of the present invention, the area on which circuit elements are mounted may be increased without increasing the size of a display apparatus such as a dual display apparatus displaying an image in dual directions.

Having described the example embodiments of the present invention, it is noted that various changes, substitutions and alterations can be made herein without departing from the spirit and scope of the invention as defined by appended claims.

What is claimed is:

1. A display apparatus comprising:
a receiving frame having a plurality of walls defining a receiving space, wherein the plurality of walls are formed around an opening;
a front-light module including a light-guide plate disposed in the receiving space and a light source disposed between a side surface of the light-guide plate and at least one wall of the plurality of walls, wherein the at least one wall is adjacent the light source;
a cover member covering the light source and a portion of an upper surface of the light-guide plate adjacent the light source; and
a display panel module including a liquid crystal display (LCD) panel and a driving printed circuit film, wherein the LCD panel faces the light-guide plate and is disposed under the front-light module in the receiving space, and the driving printed IS circuit film extends along the at least one wall adjacent the light source from an edge of the LCD panel toward the cover member.

2. The display apparatus of claim 1, wherein the driving printed circuit film comprises:
a panel printed circuit film electrically connected to the LCD panel and extending along the at least one wall adjacent the light source toward the cover member; and
an interface printed circuit film integrated on a portion of the panel printed circuit film disposed on the cover member, wherein the interface printed circuit film is electrically connected to the panel printed circuit film.

3. The display apparatus of claim 2, wherein the light source comprises:
a light-guide bar having a light-emitting surface facing the side surface of the light-guide plate, light-incident surfaces facing each other and connected to the light-emitting surface, and an upper surface connected to the light-emitting surface and the light-incident surfaces and facing a lower surface of the cover member; and
a plurality of point light sources disposed on each light-incident surface.

4. The display apparatus of claim 3, wherein the light source further comprises a power source printed circuit film on which the point light sources are mounted, and the power source printed circuit film is disposed along a lengthwise direction of the light-guide bar.

5. The display apparatus of claim 4, wherein the power source printed circuit film is attached to the lower surface of the cover member.

6. The display apparatus of claim 3, wherein the cover member is a printed circuit board (PCB) on which the point light sources are mounted.

7. The display apparatus of claim 3, wherein the cover member comprises:
an upper plate covering the light source and the portion of the upper surface of the light-guide plate;
a sidewall facing the side surface of the light-guide plate, the light-guide bar being disposed between the side surface and the light-guide plate; and
a lower plate facing a lower surface of the light-guide bar.

8. The display apparatus of claim 3, wherein the cover member comprises at least one selected from the group consisting of a plastic material and a metallic material.

9. The display apparatus of claim 3, wherein a thickness of the cover member is between about 0.1 mm and about 0.2 mm.

10. The display apparatus of claim 3, wherein a surface of the cover member comprises a light absorbing material.

11. The display apparatus of claim 10, wherein the surface of the cover member has a dark color.

12. The display apparatus of claim 3, wherein the cover member is combined with a wall of the receiving frame.

13. The display apparatus of claim 2, wherein the LCD panel comprises:
an upper substrate facing a lower surface of the light-guide plate and having a plurality of color filters formed on the upper substrate;
a lower substrate electrically connected to the panel printed circuit film, and including a transmissive pixel transmitting light having passed through the color filter to display a first image and a reflective pixel reflecting light having passed through the color filter to display a second image; and
a liquid crystal layer disposed between the upper substrate and the lower substrate.

14. The display apparatus of claim 13, wherein a prism pattern spaced apart from the cover member is formed on an upper surface of the light-guide plate.

15. The display apparatus of claim 2, wherein the display panel module further comprises a first driving element disposed on the interface printed circuit film corresponding to the cover member.

16. The display apparatus of claim 15, wherein the display panel module further comprises a second driving element disposed on the panel printed circuit film corresponding to the cover member.

17. The display apparatus of claim 16, further comprising an opening into which the second driving element is inserted formed through the interface printed circuit film.

18. The display apparatus of claim 15, further comprising an application module,
wherein the display panel module further comprises a third driving element disposed on the panel printed circuit film or the interface printed circuit film corresponding to the cover member, to drive the application module.

19. The display apparatus of claim 2, further comprising a driving substrate electrically connected to the interface printed circuit film and outputting a driving signal to the interface printed circuit film.

20. The display apparatus of claim 19, further comprising a receiving container combined with the receiving frame, wherein the receiving container rotated or translated with respect to the receiving frame, and receives the driving substrate.

21. A display apparatus comprising:
a receiving container having at least two openings to emit light in first and second directions;
an LCD panel received in the receiving container, and displaying a first image in the first direction and a second image in the second direction;
a light-generating module received in the receiving container, and including a light-guide plate facing the LCD panel and a light source facing a side surface of the light-guide plate;
a cover member covering the light source and a portion of the light-guide plate adjacent the light source; and
a printed circuit film extending from the LCD panel, and curved to enclose the light source and the cover member.

22. The display apparatus of claim 21, wherein:
the LCD panel is divided into a display area in which the second image is displayed through one of the at least two openings of the receiving container and a peripheral area covered by the receiving container, and
the cover member covers the peripheral area.

23. The display apparatus of claim 21, wherein the printed circuit film comprises:
a panel printed circuit film electrically connected to the LCD panel, and curved to enclose the light source and the cover member; and
an interface printed circuit film integrated on a portion of the panel printed circuit film disposed on the cover member, wherein the interface printed circuit film is electrically connected to the panel printed circuit film.

24. The display apparatus of claim 21, wherein the light source comprises at least one point light source providing the light-guide plate light, and
the light source further comprises a light-guide bar including a light-emitting surface facing the side surface of the light-guide plate, a plurality of light-incident surfaces facing each other and connected to the light-emitting surface, and an upper surface connected to the light-emitting surface and the light-incident surfaces and facing a lower surface of the cover member, and
a point light source is disposed on each of the light-incident surfaces.

25. The display apparatus of claim 21, wherein the light source comprises at least one point light source providing the light-guide plate light, and
the light source further comprises a power source printed circuit film on which the point light source is mounted, and the power source printed circuit film is disposed along a lengthwise direction of the light-guide bar.
